(19) United States
(12) Patent Application Publication
(10) Pub. No.: US 2011/0058044 A1
(43) Pub. Date: Mar. 10, 2011

(54) MEASUREMENT APPARATUS

(75) Inventor: Shinya Kato, Tokyo (JP)

(73) Assignee: YOKOGAWA ELECTRIC CORPORATION, Tokyo (JP)

(21) Appl. No.: 12/876,852

(22) Filed: Sep. 7, 2010

(30) Foreign Application Priority Data
Sep. 7, 2009 (JP) 2009-205494

(51) Int. Cl. H04N 17/02; G06F 3/041

(52) U.S. Cl. 348/192; 345/173

(57) ABSTRACT

[Object] To provide a measurement apparatus capable of causing different data display forms to coexist in each of a plurality of measurement channels on a common display screen with comparatively simple operation.

[Solution] In a measurement apparatus configured to display measurement signals at a plurality of measurement points on a common display screen, display form setting unit for setting a desired different display form in each of a plurality of measurement channels is provided.

### TECHNICAL FIELD

The present invention relates to a measurement apparatus and, more particularly, to improvements in the display form of a display screen in a measurement apparatus configured to display measurement signals at a plurality of measurement points on a common display screen.

### BACKGROUND ART

For example, as shown in PTL 1, one kind of measurement apparatus is a paperless recorder configured to record measurement signals at a plurality of measurement points in a desired form and display the signals on a common display screen.

FIG. 6 is a block diagram showing an example of such a paperless recorder. A display unit 1 is composed of, for example, liquid crystal, as illustrated in FIG. 6. On the surface thereof, a touch panel 2 that an operator touches with, for example, a fingertip so as to perform predetermined operation is stacked.

A control unit 3 controls the overall operation of the paperless recorder, and is provided with a panel operation detection unit 31, a group-by-group display screen generation unit 32, a group selection unit 33, and the like.

The panel operation detection unit 31 detects the operation state of the touch panel 2 by the operator and outputs a control signal associated with the operation.

In the group-by-group display screen generation unit 32, a plurality of arbitrary measurement channels are combined on the basis of the operation of the touch panel 2 by the operator so as to organize a group. A desired display form is specified in units of organized groups, and display screens for digital display, vertical bar display, horizontal bar display, trend display, and an alarm announciator, etc., are generated on a group-by-group basis, and are stored in a group-by-group display screen storage unit 4.

On the basis of the operation of the touch panel 2 by the operator, the group selection unit 33 selects a desired group-by-group display screen stored in the group-by-group display screen storage unit 4, and displays the screen on the display unit 1.

A measurement unit 5 converts an analog input signal of a measurement target (not shown) into a digital signal, and incorporates the converted digital signal as measured data into the control unit 3.

A measured data storage unit 6 sequentially stores the measured data received by the control unit 3 via the measurement unit 5.

FIG. 7 illustrates an example of a display screen in the display unit 1 of the paperless recorder of FIG. 6. In FIG. 7, the upper part of the display screen 11 is provided with an operation area 12, and a lower part thereof is provided with a data display area 13.

The operation area 12 is provided with a group number display area 12a for displaying a group number, and a screen switching button 12b for switching the display form of the data display area 13 from a digital display to a desired display form, such as vertical bar display, horizontal bar display, trend display, and an alarm announciator.

In the data display area 13, measured values of six channels from measurement channels Ch001 up to Ch006 that are grouped as group number 01 in advance on a group setting screen (not shown) are digitally displayed.

PTL 1 discloses a paperless recorder capable of displaying a plurality of screens as necessary at the same time.

PTL 1: Japanese Unexamined Patent Application Publication No. 2001-21386

### SUMMARY OF INVENTION

### Technical Problem

However, according to the structure of FIGS. 6 and 7, in a case where a channel to be displayed is to be added to a group, or a channel whose display is unnecessary is to be deleted from a group, it is necessary to move to a group setting screen each time so as to change the setting of the group, presenting the problem that these series of operations are complex.

It is not intended that a plurality of different data display forms coexist within the screen of one group. When switching the data display form, it is necessary to click on the screen switching button 12 so as to switch the entire screen in units of groups.

The present invention solves these problems. An object of the present invention is to provide a measurement apparatus capable of, with a comparatively simple operation, causing data display forms that are different for a plurality of measurement channels to coexist on a common display screen.

### Solution to Problem

One aspect of the disclosure provides a measurement apparatus configured to display measurement signals at a plurality of measurement points on a common display screen, wherein each of a plurality of measurement channels is provided with a display form setting unit for setting a desired different display form.

Another aspect of the disclosure provides the measurement apparatus, wherein the display form setting unit includes a measurement channel addition unit and a measurement channel deletion unit.

Another aspect of the disclosure provide the measurement apparatus wherein the display form setting unit further includes snapshot unit for storing display screen information containing a channel number of each of the measurement channels on a display screen that is currently being displayed, types of display forms, and corresponding arrangement position information.

Another aspect of the disclosure provides the measurement apparatus wherein the display form setting unit is operated via a touch panel.

### ADVANTAGEOUS EFFECTS OF INVENTION

According to the present invention, a measurement apparatus in which data display forms that are individually different for a plurality of measurement channels coexist on a common display screen can be realized.

### BRIEF DESCRIPTION OF DRAWINGS

FIG. 1 is a block diagram showing an embodiment of the present invention.

FIG. 2 shows an example of a display screen in a measurement apparatus of FIG. 1.

FIG. 3 shows another example of a display screen in the measurement apparatus of FIG. 1.

FIG. 4 is a block diagram showing another embodiment of the present invention.

FIG. 5 shows an example of a display screen in a measurement apparatus of FIG. 4.

FIG. 6 is a block diagram showing an example of a measurement apparatus of the related art.

FIG. 7 shows an example of a display screen in the measurement apparatus of FIG. 6.

FIG. 8 shows an example of a computer system which can implement an embodiment of the invention.

FIG. 9 shows a detailed example of the computer which can implement an embodiment of the invention.

### DESCRIPTION OF EMBODIMENTS

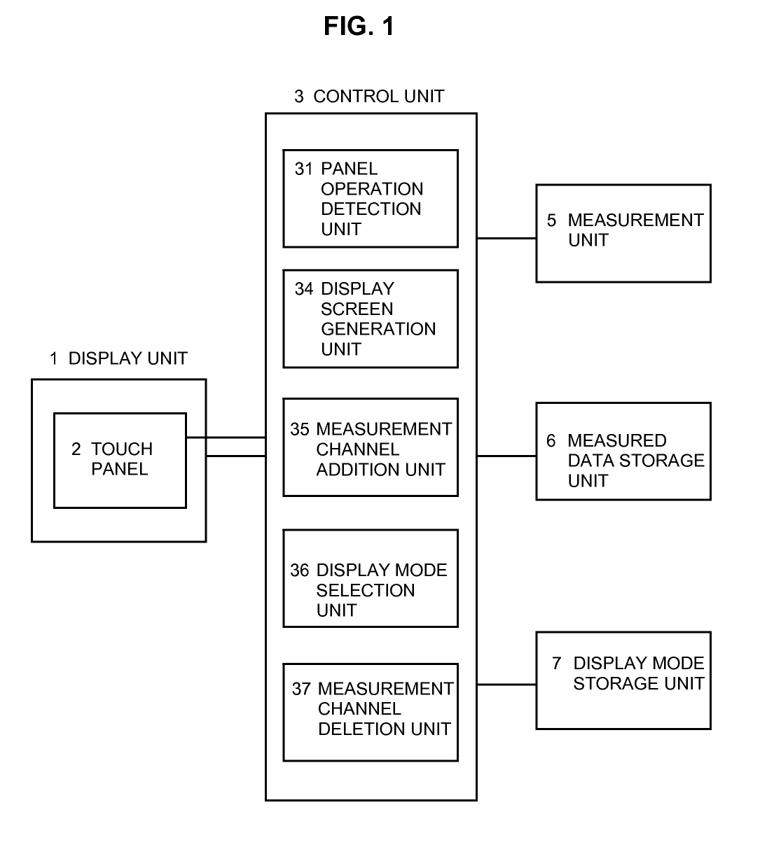

Embodiments of the present invention will be described below in detail with reference to the drawings. FIG. 1 is a block diagram showing an embodiment of the present invention. Components common to FIG. 6 are designated with the same symbols, and repeated description thereof is omitted.

In FIG. 1, the control unit 3 is provided with, in addition to the panel operation detection unit 31, a display screen generation unit 34, a measurement channel insertion unit 35, a measurement channel deletion unit 36, a display form selection unit 37, and the like.

On the basis of the touch operation of the touch panel by an operator, the panel operation detection unit 31 determines that a click operation has been performed when a touch is released without changing the touched coordinates, determines that a dragging operation has been performed when the touched coordinates of the touch panel change while the touch panel is being touched, and determines that an operation of dropping a touch target of the drag start coordinates has been performed when the touch is released in a dragged state.

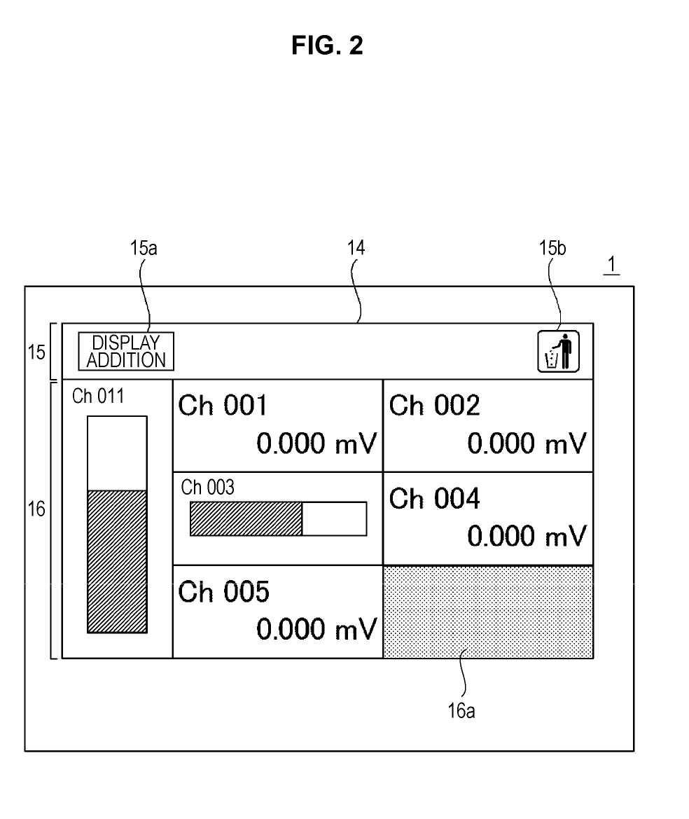

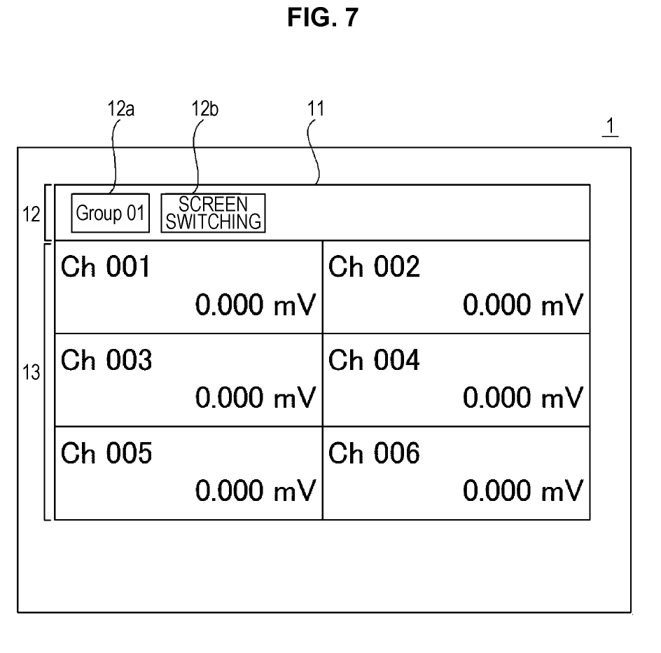

The display screen generation unit 34 generates, for example, a display screen 14 such as that illustrated in FIG. 2. In FIG. 2, similarly to FIG. 7, the upper part of the display screen 14 is provided with an operation area 15, and the lower part thereof is provided with a data display area 16.

The operation area 15 is provided with a data display addition button 15a for adding the data display of a desired measurement channel in the data display area 16, and a deletion icon 15b for deleting the data display of a measurement channel displayed in the data display area 16.

In the data display area 16, measured values of a plurality of measurement channels are displayed in such a manner as to be set individually. More specifically, the measured values of the measurement channels 001, 002, 004, and 005 are digitally displayed, the measured values of the measurement channel 003 are subjected to horizontal bar display, and the measured values of the measurement channel 011 are subjected to vertical bar display.

When the data display addition button 15a of the operation area 15 is touch-selected, the measurement channel addition unit 35 is started, and a vacant data display unit is added to the data display area 16. In FIG. 2, a vacant data display unit 16a has been added below the measurement channel 004.

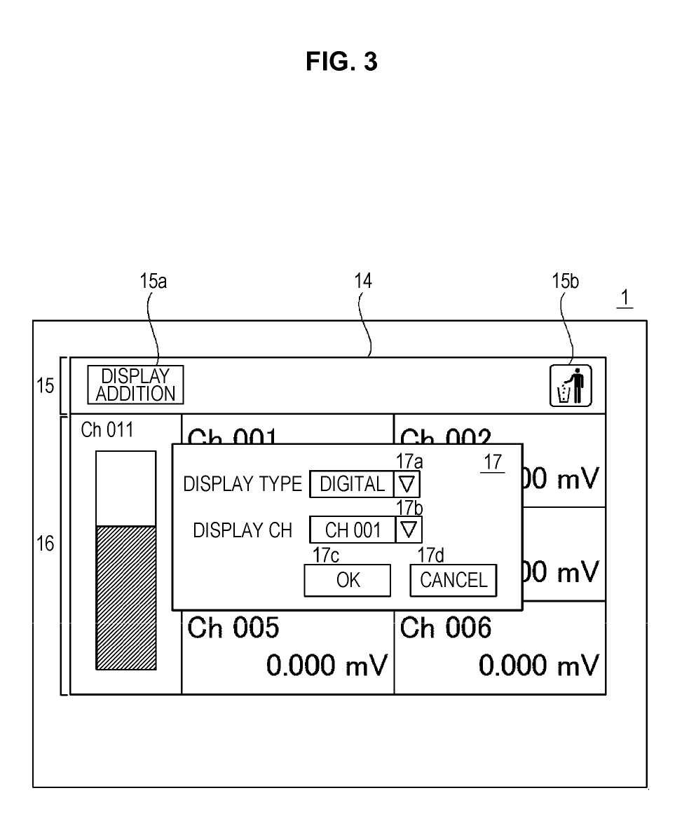

Furthermore, on the display screen 14 of FIG. 2, when each item of data display is clicked on, the display form selection unit 36 is started, and a data display setting dialog 17 such as that shown in FIG. 3 is pop-up-displayed.

As shown in FIG. 3, the data display setting dialog 17 is provided with a display type selection display unit 17a for selectively displaying the type of display form, a display channel selection display unit 17b for selectively displaying a measurement channel, an OK button 17c for setting and displaying the type of display form and the display channel, and a cancel button 17d for cancelling the type of display form and the display channel, which are selectively displayed.

Referring again to FIG. 2, when each item of data display in the data display area 16 of the display screen 14 is dragged and dropped onto the deletion icon 15b, the measurement channel deletion unit 37 is started, and the data display that has been dragged and dropped is deleted.

As described above, by touch-operating a predetermined portion corresponding to the display screen 14 of the touch panel 2, which is made to overlap the display unit 1 by the operator while data is being displayed, it is possible to add, change, or delete the display data without reading an instruction manual or the like, and it is possible to intuitively generate a simplified custom screen.

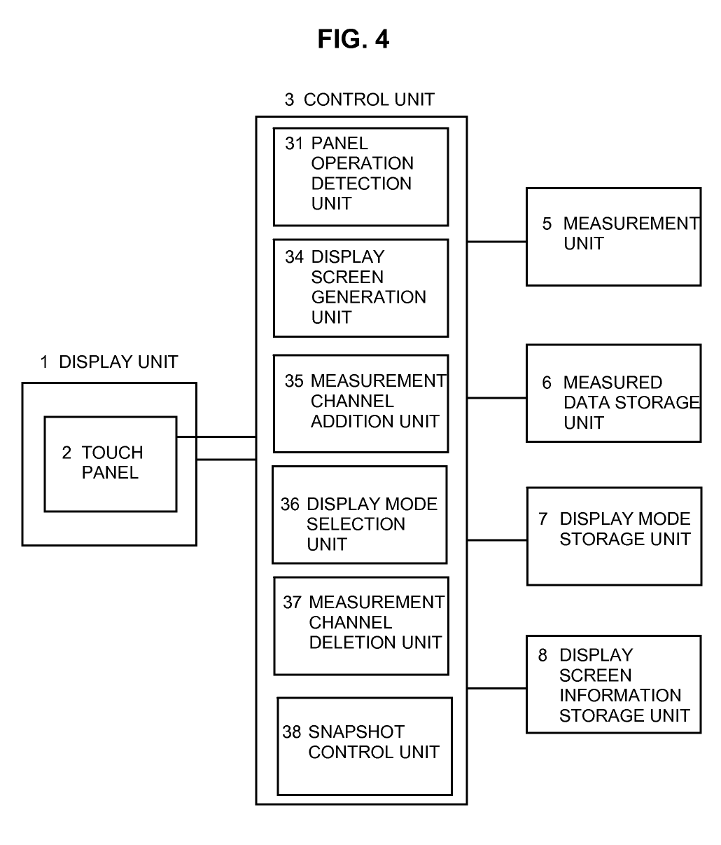

FIG. 4 is a block diagram showing another embodiment of the present invention. Components common to those of FIG. 1 are designated with the same reference numerals. In FIG. 4, a snapshot control unit 38 is added to the control unit 3, and a display screen information storage unit 8 is provided therein.

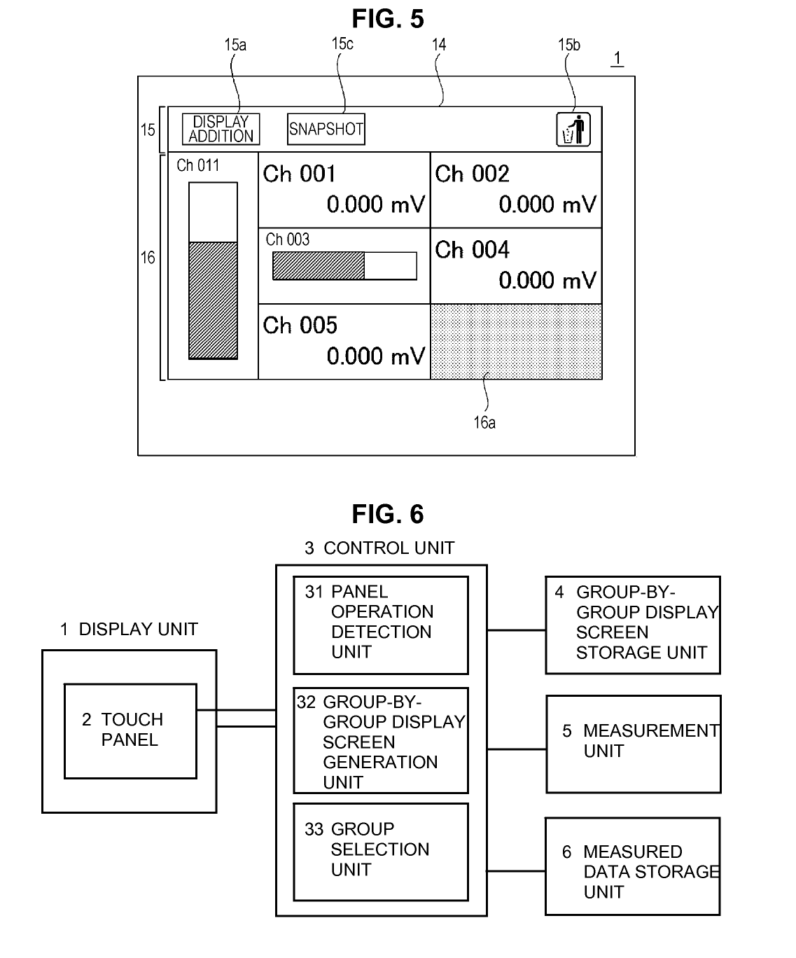

FIG. 5 shows an example of a display screen in the measurement apparatus of FIG. 4. Components common to those of FIG. 2 are designated with the same reference numerals. In FIG. 5, a snapshot button 15c is provided in the operation area 15.

By touch-selecting the snapshot button 15c by the operator while data is being displayed as shown in FIG. 5, the snapshot control unit 38 of the control unit 3 is started. Display screen information including the channel number of each measurement channel on the display screen that is currently being displayed, types of display forms, and corresponding arrangement position information is stored in the display screen information storage unit 8.

This display screen information stored in the display screen information storage unit 8 can be called up anytime and displayed on the display screen of the display unit 1. With this display screen information calling function, the display screen information stored in the display screen information storage unit 8 can be used instead of the group-by-group display screen in the structure of the related art, shown in FIGS. 6 and 7.

Furthermore, on the basis of the operation of the touch panel 2, by dragging the display data of one of the measurement channels and dropping the display data onto the display data of another measurement channel, the arrangement position can be interchanged between these measurement channels. By utilizing this measurement channel arrangement position interchanging function, it is possible to intuitively realize, as a custom screen, the arrangement of each measurement channel close to the preference of a user.

Furthermore, by setting image data associated with measured data stored in the measurement apparatus as a selection target and image data of a camera that is externally provided to the measurement apparatus, in the display type selection display unit 17a of the data display setting dialog 17 of FIG. 3, it is possible to display measured data and image data of a measurement target on a common display screen as necessary in such a manner as to be associated with each other. Thus, the measurement function of the measurement apparatus can be extended and fully prepared.

Furthermore, by adding a network function, it is possible to obtain the data of another measurement apparatus. By causing the display type selection display unit 17a of the data display setting dialog 17 of FIG. 3 to display the data information of another measurement apparatus that is set as a target, the data of a plurality of measurement apparatuses can be displayed with one measurement apparatus.

Furthermore, the arrangement information stored using the above-mentioned snapshot button 15c can be shared among a plurality of measurement apparatuses via a network.

In each of the above-described embodiments, an example has been described in which, on the basis of the touch operation of the touch panel, a desired display form is set to each measurement channel. Alternatively, the present invention can be applied to a measurement apparatus of an operation panel type.

As has been described above, according to the present invention, it is possible to realize a measurement apparatus in which different data display forms can be made to individually coexist in a plurality of measurement channels and a screen that a user intuitively wants to display can be generated comparatively easily, and is suitable for use in a paperless recorder that performs measurement display recording of measurement signals at a plurality of various measurement points.

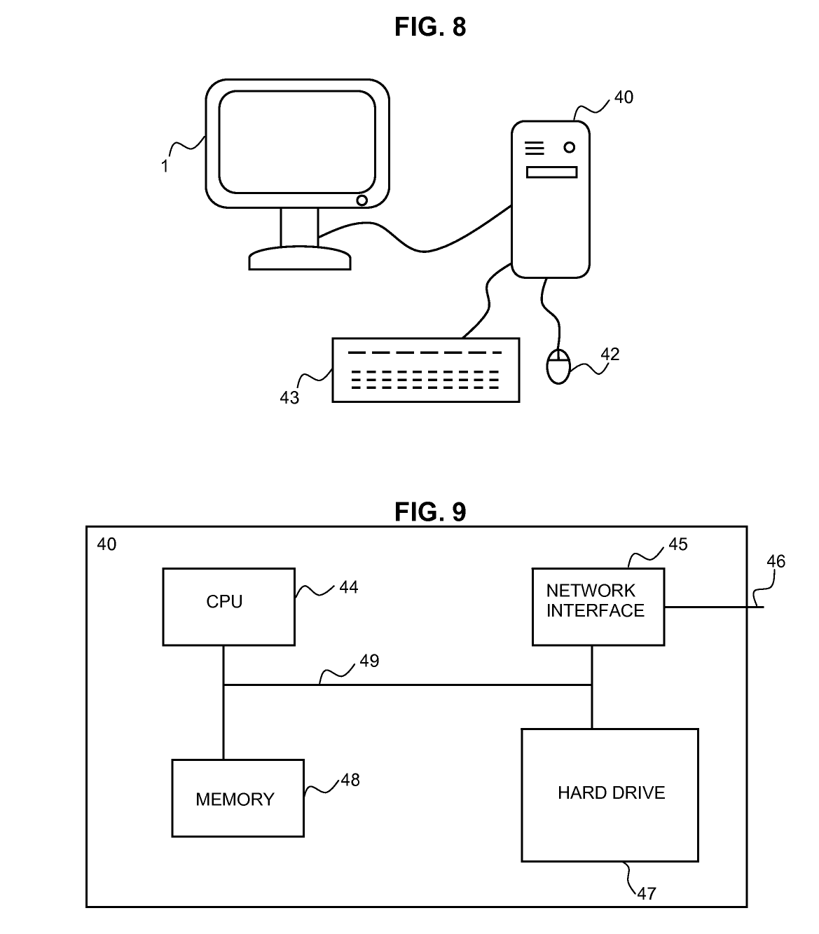

FIG. 8 shows a computer 40 configured to perform the tasks of the control unit 3. Computer 40 has various external input means such as a keyboard 43 and mouse 42. Computer 40 may also have a display, such as display unit 1. Display unit 1 may also include a touch panel 2 (not shown). Computer 40 can be connected to other computer or input devices such as measurement devices, storage devices and display devices.

FIG. 9 shows a more detailed view of computer 40. Computer 40 includes among other things, a central processing unit (CPU) 44 configured to perform the functions discussed with respect to control unit 3. Computer 40 may also include a network interface 45, output 46, memory 48 and hard drive 47, all connected via a bus 49.

1. A measurement apparatus comprising:
a common display screen configured to display measurement signals at a plurality of measurement points,
wherein each of a plurality of measurement channels is provided with a display form setting unit, setting a desired different display form.

2. The measurement apparatus according to claim 1, wherein the display form setting unit includes a measurement channel addition unit and a measurement channel deletion unit.

3. The measurement apparatus according to claim 1, wherein the display form setting unit further includes a snapshot unit storing:
display screen information containing a channel number of each of the measurement channels on a display screen that is currently being displayed, types of display forms, and
corresponding arrangement position information.

4. The measurement apparatus according to claim 1, wherein the display form setting unit is operated via a touch panel.

5. The measurement apparatus according to claim 2, wherein the display form setting unit further includes a snapshot unit storing:
display screen information containing a channel number of each of the measurement channels on a display screen that is currently being displayed, types of display forms, and
corresponding arrangement position information.

6. The measurement apparatus according to claim 2, wherein the display form setting unit is operated via a touch panel.

7. The measurement apparatus according to claim 3, wherein the display form setting unit is operated via a touch panel.

8. The measurement apparatus according to claim 5, wherein the display form setting unit is operated via a touch panel.
